(19) United States
(12) Patent Application Publication
(10) Pub. No.: US 2009/0003154 A1
(43) Pub. Date: Jan. 1, 2009

(54) INFORMATION RECORDING/REPRODUCING APPARATUS

(76) Inventors: Tsutomu USUI, Tokyo (JP); Akinobu Watanabe, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/059,168

(22) Filed: Mar. 31, 2008

(30) Foreign Application Priority Data
Jun. 28, 2007 (JP) 2007-169872

(51) Int. Cl. G11B 5/09

(52) U.S. Cl. 369/47.1

(57) ABSTRACT

In a recording apparatus for a file system conforming to UDF 2.6, performance is improved when a MetaData file (MD) representing management information and its MetaDataMirror file (MDM) are recorded. The MDM file is not recorded before finalization is executed and when finalizing, a copy of the latest MD file is recorded as the MDM file.

### BACKGROUND OF THE INVENTION

The present invention relates to an information recording/reproducing apparatus and an information recording method.

To explain UDF and UDF 2.5 briefly, reference is made to JP-A-2005-243079 (paragraph Nos. 0002 to 0005, 0011 and 0013) which gives a description reading “Originally, the UDF has been known as a file format adapted to record and manage files on a recording medium such as an optical disc typified by a DVD (Digital Versatile Disc) and its standards have gradually undergone version up and the UDF 2.5 is proposed at present.

A file system conforming to the UDF 2.5 features duplication of management information and concentration of pieces of management information. The management information referred to herein is information indicating which position of a recording medium what file exists at and is updated at the time when a file is written to the recording medium or conversely, a file is erased from the recording medium.

Duplication of management information signifies recording of identical pieces of management information at two locations spaced apart from each other on the recording medium, respectively, (for example, at inner and outer circumferential locations on the disc). This is advantageous in that even in the event that one of the identical pieces of management information recorded at the two locations supposedly becomes unreadable because of impairment or degradation, reading out the other suffices and therefore, such an accident that a recorded file cannot be read, either, owing to a failure to read the management information can be prevented from coming up.

Concentration of management information pieces signifies that individual pieces of management information can be recorded sequentially on the recording medium without dividing them. Advantageously, this enables the management information to be read quickly and as a result, time consumed for going through read-out of the recorded file can be shortened.”

The aforementioned reference literature aims at recording medium conforming to the UDF 2.5 as above and raises a problem reading “In the above-described UDF 2.5, the management information is duplicated and these pieces of information are recorded at mutually spaced-apart locations on the recording medium and therefore, in updating these pieces of information frequently, a pickup for writing data on the recording medium is also required to be moved frequently back and forth between the locations spaced apart on the recording medium. Consequently, the seek time of the pickup is prolonged during the movement to keep the pickup from returning quickly to a vital position where video data is to be recorded.” and describes the use of such a countermeasure against the problem as constituted by “a write module which writes, as a single file, inputted data on a recording medium, a creation module which creates, when the data inputted by the write module is written as a single file on the recording medium, management information for reading the file written on the recording medium, and a recording module which records the management information created by the creation module in a first area formed in the recording medium when the management information is created and in a second area different from the first area, also formed in the recording medium, when the recording medium is ejected.”

The file format of the aforementioned UDF 2.5 aims at a rewritable type recording medium such as for example BD-RE (Blu-ray Disc Rewritable) and recently, a file format of UDF 2.6 targeting a write once type recording medium such as for example BD-R (Blu-ray Disc Recordable) has been proposed.

Even in the write once type recording medium conforming to the UDF 2.6, when the management information (Meta Data being hereinafter referred to as an MD file) is updated as in the case of read many of user data similarly to the rewritable recording medium conforming to the UDF 2.5, the MD file is recorded in a management information area (hereinafter referred to as an MD area). Further, to meet the duplex of the management information, Meta Data Mirror information for backup of the MD file (hereinafter referred to as an MDM file) is also recorded in an MDM area.

Incidentally, the write once recording medium does not have the ability to rewrite information and therefore adopts a pseudo over write (POW) scheme. In the POW scheme, when a host issues a recording instruction to again record data in a recorded area where information has already been recorded in the write once recording medium, a drive unit automatically write the data in an area for rewrite as if the information were overwritten in that recorded area.

For example, in case after an MD file has once been recorded in an MD area, an MD file is desired to be recorded newly in the MD area, the POW is executed. If the area where the file has once been recorded is a heading area positioned in the head of MD areas, the new MD file is recorded in an area next to the heading area. Recording in an unrecorded area substituting for the recorded area is termed exchange recording. Then, link information to the effect that exchange recording has been executed from the heading area to the area next thereto is recorded in an area different from the MD area, termed a defect list management area. With the above expedient, even in the write once type recording medium, the MD file can be handled as though it were overwritten in the heading one of MD areas.

This holds true for an MDM file for backup of the MD file, so that by performing POW in an MDM area and recording link information in a defect list management area, the MDM file can be handled as though it were overwritten in the MDM area even on a write once type recording medium.

### SUMMARY OF THE INVENTION

The technique of the above-described reference literature considers update of an MD file in a rewritable recording medium conforming to the UDF 2.5 but fails to take into account update of an MD file in a write once recording medium conforming to the UDF 2.6.

Accordingly, when recording is performed on a recording medium conforming to the UDF 2.6 by using the conventional technique, an MDM file about to be overwritten during, for example, injection is not overwritten in an MDM area for which recording is completed on a disc but is recorded in another unoccupied area (exchange area) through the POW process. Consequently, a POW is generated at the MDM area every injection and a majority of links to the exchange area are generated in connection with the MDM file. With many links generated as above, the processing is complicated during both the recording and the reproduction and the performance is degraded. This is because during recording, the processing time increases as each recording of the MDM file proceeds and during reproduction, the processing time such as the seek time for the pickup to trace many pieces of link information increases.

Since the MD area or the MDM area uses part of a user area, the area capable of recording user data reduces in proportion to an increase in number of MD files or MDM files to be recorded. Therefore, it is preferable that the number of recording operations of the MD file or MDM file be as minimized as possible but the reference literature fails to take this point into account.

Further, the capacity of the MD area or MDM area is finite and when the MD area or MDM area is filled up after the POW has been repeated many times, the recording medium will become unusable even if an unoccupied capacity remains in, for example, the user data area. Especially when operation ranging from recording start to recording stop is repeated frequently for scenes within a short period of time as in the case of a video camera, this phenomenon takes place outstandingly. The technique of the reference literature does not consider this point, either.

Accordingly, the present invention intends to solve the above problems and it is an object of this invention to provide an information recording/reproducing apparatus capable of realizing proper recording or reproducing operation.

According to the present invention, the aforementioned problems can be solved by embodiments to be described hereinafter but the invention is in no way limited to the embodiments.

For example, in an information recording/reproducing apparatus according to this invention, user data is recorded on a recording medium having a first management information area and a second management information area or the user data is reproduced from the recording medium.

According to an embodiment of this invention, in the information recording/reproducing apparatus, the management information is recorded in the first management information area until the recording medium is finalized and when the recording medium is finalized, a copy of the management information is recorded in the second management information area.

Advantageously, according to the present invention, an information recording/reproducing apparatus capable of realizing proper recording or reproduction operation can be provided.

### BRIEF DESCRIPTION OF THE DRAWINGS

These and other features, objects and advantages of the present invention will become more apparent from the following description when taken in conjunction with the accompanying drawing wherein:

FIG. 1 is a schematic block diagram showing an embodiment of an information recording/reproducing apparatus of the invention.

FIG. 2 is a diagram showing an internal state of an optical disc before finalization in embodiment 1 of the invention.

FIG. 3 is a diagram showing an internal state of the optical disc after finalization in the embodiment 1.

FIG. 4 is a flowchart showing operation of the information recording/reproducing apparatus in the embodiment 1 of the invention.

FIG. 5 is a flowchart showing operation of the information recording/reproducing apparatus in embodiment 2 or 3 of the invention.

FIG. 6 is a diagram showing an internal state of the optical disc before finalization in the embodiment 2 or 3 of the invention.

### DETAILED DESCRIPTION OF THE EMBODIMENTS

The present invention will now be described by way of example with reference to the accompanying drawings.

### Embodiment 1

In the present embodiment, an example will be described in which an MDM file is recorded in an MDM area during finalization. In a CD-R or DVD-R, finalization is a final process for ensuring reproduction interchange so that data recorded on a write once read many optical disc may be reproduced with another player but in a BD-R, standards are such that the reproduction interchangeability can be maintained without performing finalization.

Therefore, in the BD-R, the process of finalization can be dispensed with. But in the present embodiment a process of recording an MDM file in an MDM area is defined as finalization of BD-R and is used. Further, it is possible through the finalization to record the MDM file in the MDM area and at the same time to place the MDM file in condition unallowed to undergo write once read many to/from a disc.

Alternatively, the process for disabling the write once read many mode may be realized through a disc close process.

It is also to be understood that the finalization is executed at the timing that the unoccupied capacity of disc reaches a constant level or a user issues a command to execute finalization.

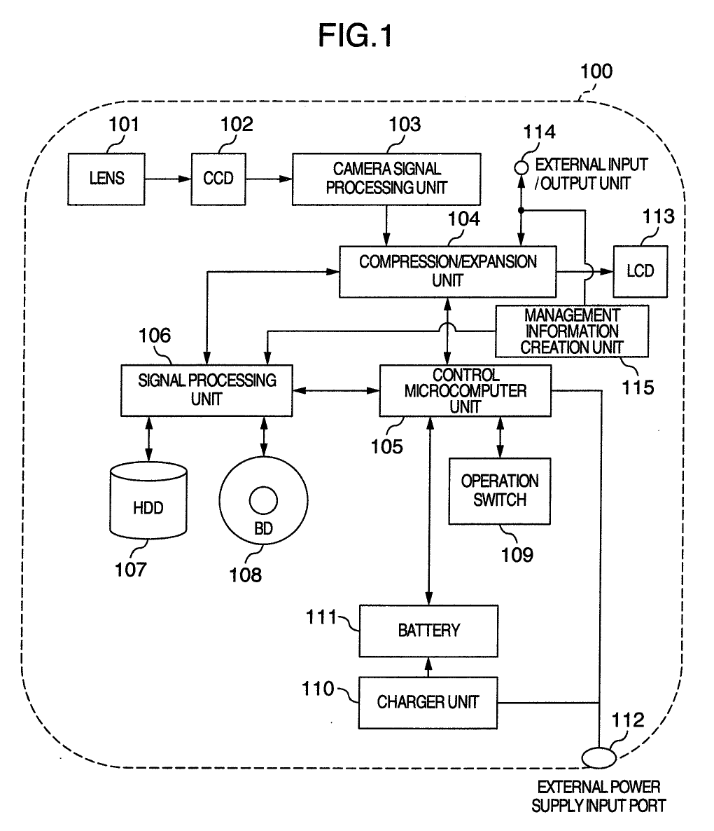

Referring first to FIG. 1, an example of construction of a camera exemplifying an information recording/reproducing apparatus 100 will be described.

Reference numeral 101 designates a lens, 102 an image pickup sensor (CCD), 103 a camera signal processing unit, 104 a compression/expansion unit, 105 a control microcomputer unit, 106 a signal processing unit, 107 a hard disc drive (HDD), 108 a disc medium (for example, BD or DVD) unit, 109 an operation switch, 110 a charger unit, 111 a battery, 112 an external power supply input port, 113 a liquid crystal display (LCD), 114 an external output interface (I/F) and 115 a management information creation unit. For convenience of explanation, individual components are illustrated separately in FIG. 1 but they may suitably be agglomerated in one chip in accordance with a circuit design or the like because this modification may lead to advantages of easiness of control and space saving in circuit design.

Firstly, operation of the information recording/reproducing apparatus shown in FIG. 1 will be described. An image of a photographic object is captured by means of the CCD 102 via the lens 101 and the image captured by the CCD is converted into an electric signal which in turn is converted into a video signal with the camera signal processing unit 103.

Subsequently, the video signal is converted into a digital video signal with the signal compression/expansion unit 104 controlled by the control microcomputer 105. By transferring to the input to the external input/output terminal 114, an external input video signal can also be converted into a digital video signal.

The signal converted to the digital video signal is recorded on an external storage such as the BD or DVD, or the aforementioned HDD by means of the signal processing unit 106. In this manner, data is recorded on a recording medium such as a BD-R (Blu-ray Disc Recordable) formatted pursuant to, for example, the UDF 2.6. If the management information such as MD information or MDM information is required to be updated in accordance with write once read many of user data, for example, management information is created in the management information creation unit 115 and recorded similarly on the recording medium.

Further, while controlling the control microcomputer by operating the operation switch 109, the video signal recorded on the BD or DVD is read out and recorded on the HDD by means of the signal processing unit, with the result that a process of dubbing between media can be carried out. Similarly, a video signal recorded on the HDD can be read out to permit it to be recorded on the BD or DVD.

The signal recorded on the storage can be expanded to a video signal by means of the video compression/expansion unit so as to be delivered to the input/output terminal and also to be displayed on the liquid crystal display (LCD) 113. The display is in no way limited to the liquid crystal display but it may be an organic EL display, for example.

Further, the external power supply input port 112 is connected to, for example, an AC power supply to feed electric power externally. With the electric power fed through the external power supply input port, the battery 111 can be charged with the help of the charger unit 110. Then, when electric power is fed through the external power supply input port, the apparatus is operated with the external power supply but when electric power is not fed from the external power supply, the apparatus can be operated by electric power fed from the battery. However, it is not always necessary that the function needed for charging is totally built in the apparatus but part or all of the function needed for this purpose may be provided externally of the external power supply input port.

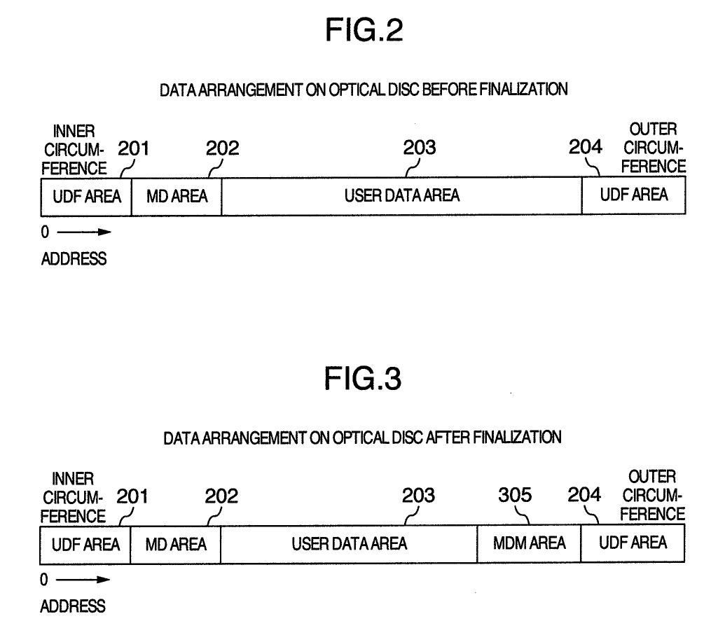

The arrangement of recording data in an optical disc such as BD will be described with reference to FIGS. 2 and 3.

The optical disc recorded with data by means of the video recording/reproducing apparatus of the present invention has its internal state as shown in FIG. 2 before finalization (write once read many). The FIG. 2 optical disc is depicted from left in order of address, indicating that the left side is the inner circumference of address 0 and the right side is the outer circumference. Reference numeral 201 designates a UDE area, 202 an MD area, 203 a user area and 204 a UDF area.

Designated by 204 is also the UDF area but in this area, a backup file of an UDF file recorded in the UDF area 201 is copied. The UDF file referred to herein is a file for managing a volume structure (indicating which area in UDF format what information is recorded in) of a disc based on the UDF. Recorded in the MD area 202 is an MD file as described previously. The MD file is a file like a directory structure of user data, for example, adapted to manage a data structure in the user area called a file structure. Further, the user data is recorded in the user area 203. The previously-described defect list management area is arranged inner-circumferentially of the UFD area, for example, but in the present embodiment, its illustration is omitted for simplicity of explanation.

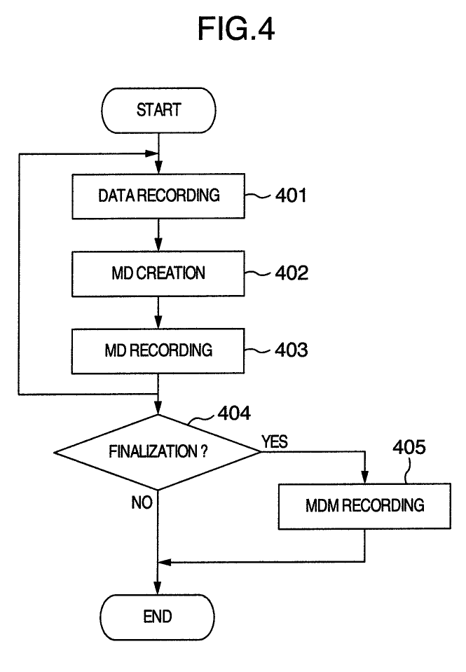

Illustrated in FIG. 3 is an internal state of the optical disc after finalization. Portions like those in FIG. 2 are designated by identical reference numerals and they will not be described herein. Differing from FIG. 2, there is an MDM area 305. In the present embodiment, during finalization, an MDM file is recorded in the MDM area. This operation flow will be described with reference to FIG. 4.

A flowchart in FIG. 4 shows operation of the information recording/reproducing apparatus in the present embodiment. Firstly, in step 401, data is recorded in the user area and an MD file is created in step 402. In step 403, the MD file is recorded and if data recording continues, the above process is repeated. In step 404, the presence or absence of an instruction to proceed with a finalization process is decided and in the absence of the instruction for finalization process (in the case of No), the MDM file is not recorded but in the presence of the instruction for finalization process (in the case of Yes), an MDM file representing a copy of the MD file is recorded in. step 405 during the finalization process. In this manner, during the finalization, a copy of the latest link information is recorded in the MDM area.

Embodiment 1 operates as above and can attain the following meritorious effects.

(1) A degradation in performance can be prevented during recording. The reason for this is that as compared to the scheme in which the MDM file is recorded each time the MD file is updated or the scheme in which the MDM file is recorded every injection as in the technique described in the background art, the number of operations of recording the MDM file can be reduced.

(2) A degradation in performance can be prevented also during reproduction. By reducing the number of operations of recording the MDM file, the number of events of POW occurrence, that is, the number of events of link generation can be reduced and the seek time of the pickup can be shortened. Therefore, in the event that the necessity for reading the MDM file occurs during data access on account of destruction of, for example, the MD file, the performance can be improved in proportion to the reduction in the number of links to the MDM file.

(3) The user can properly maintain an area capable of recording data. This is because by reducing the number of MDM file recording operations, an increase in the capacity of MDM area can be prevented.

(4) The number of data recording operations the user can perform can be maintained properly. The capacity of each of the MD area and MDM area is often determined according to an approximate proportion by which the total capacity of the two areas is partitioned in relation to the user area. Therefore, if the capacity of the MDM area can be prevented from increasing by reducing the number of operations of recording the MDM file, the capacity of the MD area can be maintained proportionately, thus maintaining the number of POW operations, that is, the number of operations of data recording the user can perform.

In an example to which embodiment 1 is applied, access may first be made to not MD area but an MDM file in the MDM area during reproduction of the recording medium recorded with data as described previously. The use of the MDM file is advantageous in that a link to an exchange area need not be consulted and so access to the management information can be smoothed, alleviating a degradation in performance during data accessing.

### Embodiment 2

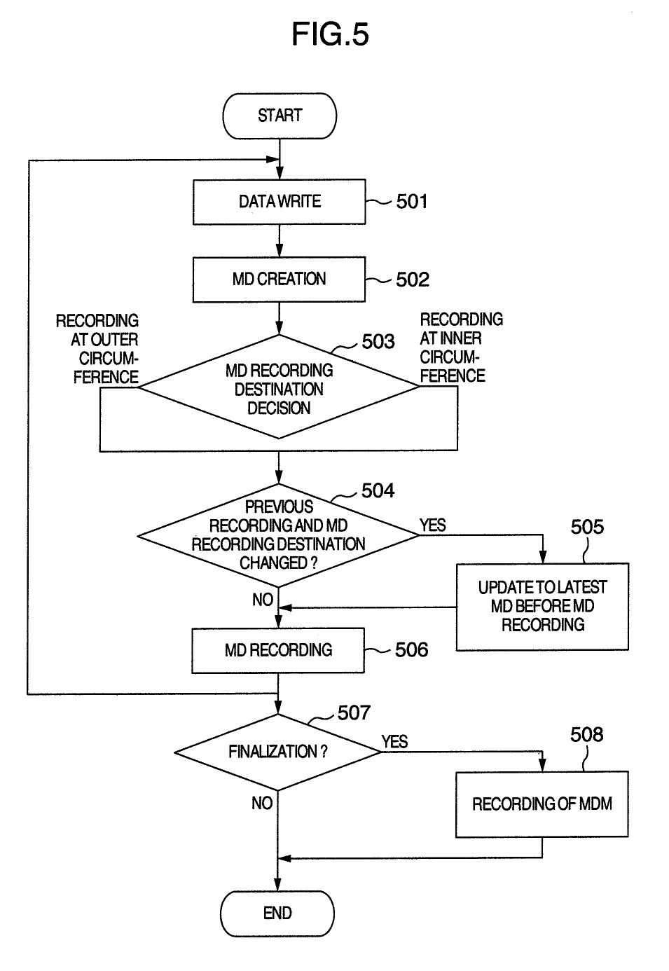

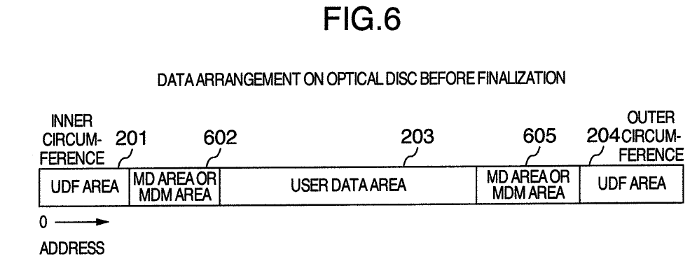

Embodiment 2 will now be described by making reference to FIGS. 5 and 6.

In FIG. 6, parts like those in embodiment 1 are designated by like reference numerals and will not be explained herein. Differing from embodiment 1, areas 602 and 605 are provided which are each used as an MD area or an MDM area. The MD area and the MDM area will both be termed a management information area.

In the present embodiment, management information (MD file) is recorded alternately selectively in the management information area 602 at the inner circumference and in the management information area 605 at the outer circumference to update the management information.

In this case, with the MD file recorded in the inner circumferential management information file 602, the inner circumferential area is the MD area and the outer circumferential management information area is the MDM area. Conversely, with the MD recorded in the outer circumferential management information area 605, the outer circumferential area is the MD area and the inner circumferential management information area 602 is the MDM area. This operation flow will be explained with reference to FIG. 5.

An operation flow in the information recording/reproducing apparatus in the present embodiment is shown in FIG. 5. Firstly, in step 501, data is recorded in the user area and, in step 502, an MD file is created. It is decided in step 503 whether the MD file is to be recorded in the inner circumferential management information area 602 or in the outer circumferential management information area 605. In step 504, it is decided whether a destination of recording of the MD is changed and with the recording destination of the MD file changed, the management information area for recording the MD file next is updated to the latest state in step 505. In step 506, the MD file is recorded in the inner or outer circumferential management information area determined in the step 503 and the area recorded with the data is set as an MD area. If data recording continues further, the above process is repeated.

In step 507, the presence or absence of an instruction to execute a finalization process and in the absence of the instruction of finalization process (in the case of No), the MDM file is not recorded but in the presence of the instruction of finalization process (in the case of Yes), the MDM file is recorded in step 508 during the finalization process. The area in which the MDM file is recorded is the management information area arrayed oppositely to the management information area in which the MD file is recorded. This is a must to meet the duplex of the management information.

In this manner, the number of linking operations to the exchange area based on the POW is distributed to the inner and outer circumferential management information areas.

In deciding the recording destination management information areas in the step 503, switchover between the inner and outer circumferential areas is carried out each time when, for example, one recording operation is complete, a few recording operations are complete, the recording medium is mounted (inserted) or a constant time is complete or has elapsed. This makes it possible to select a suitable recording method in accordance with data to be recorded.

Through the operation of embodiment 2 described as above, the following effects can be attained in addition to the effects (1) to (4) attained by embodiment 1.

By performing switchover between the management information areas to be recorded with the MD file, the frequency of generation events of the link to the exchange area generated pursuant to the POW can be distributed to the inner and outer circumferential management information areas. This can ensure that even with any one of the inner and outer circumferential management information areas used during reproduction, the performance during data accessing can be averaged and improved.

### Embodiment 3

Next, embodiment 3 will be described.

The present embodiment will be described by making reference to FIGS. 5 and 6 used in connection with embodiment 2. The present embodiment is different from the embodiment 2 in that it is decided in step 503 of FIG. 5 whether an MD file is recorded in the inner circumferential management information area or in the outer circumferential management information area depending on a position at which recording in the user area is executed.

In connection with the step 503, the recording position in the user area may for example be determined as follows. A midpoint (midmost recording position) is set at an address in the user area at which the seek distance of the pickup between the management information areas 602 and 605 is just mid (the seek distance from the recording position in the user area to the both areas is equal to each other and when user data is recorded on the side inner-circumferential of the midpoint, the MD file is recorded in the inner circumferential management information area 602 but conversely, when the user data is recorded outer-circumferentially of the midpoint, the MD file is recorded in the outer circumferential management information area 605.

With this structure, the following effects can be accomplished in addition to the effects (1) to (4) in the embodiment 1.

By using the inner circumferential management information during recording to an inner circumferential position in the user area and using the outer circumferential management information during recording to an outer circumferential position in the user area, the seek amount of pickup the drive applies can be reduced during recording of the management information. For example, when the video camera is used, battery drive is often used. In this instance, the reduced seek amount of the pickup is particularly useful to bring about the battery reduction preventive effect.

In the above description, the position at which the seek distance is just mid is defined as the midpoint but alternatively, a position at which the seek time is halved or a position weighted by the frequency of occurrence of seek may be defined as a midpoint to attain a similar effect.

The foregoing embodiments have been described as showing the example in which the UDF area 201 and the management information area 202 or 602 are recorded inner-circumferentially of the disc and the UDF area 204 and the management information area 305 or 605 are recorded outer-circumferentially of the disc but this is not limitative and they may be arranged either inner-circumferentially or outer-circumferentially as necessary. By performing recording operation of the MDM file as in the foregoing individual embodiments, the effects of the individual embodiments can be attained similarly regardless of the fact that the management information area is either inner circumferential or outer circumferential.

Further, the foregoing embodiments have been described as targeting the camera but this is not limitative and in the case of an installation type apparatus, for example, the lens or CCD can be dispensed with.

While we have shown and described several embodiments in accordance with our invention, it should be understood that disclosed embodiments are susceptible of changes and modifications without departing from the scope of the invention. Therefor, we do not intend to be bound by the details shown and described herein but intend to cover all such changes and modifications that fall within the ambit of the appended claims.

1. An information recording/reproducing apparatus for recording user data on a recording medium having a first management information area, a second management information area and a user data area or for reproducing the user data from said recording medium, comprising:
a management information creation module which creates management information for managing the user data;
a recording module which operates to record the user data and the management information on said recording medium; and
a control module which controls said management information creation module and said recording module,
wherein said management information is recorded in said first management information area until said recording medium is finalized and when said recording medium is finalized, a copy of said management information is recorded in said second management information area.

2. An information recording/reproducing apparatus for recording user data on a recording medium having a first management information area, a second management information area and a user data area or for reproducing the user data from said recording medium, comprising:
a management information creation module which creates management information for managing the user data;
a recording module which operates to record the user data and the management information on said recording medium; and
a control module which controls said management information creation module and said recording module,
wherein said management information is recorded by switching over a recording destination of said management information to either said first or second management information area at a predetermined timing until said recording medium is finalized and when said recording medium is finalized, a copy of said management information is recorded in the other management information area than the management information area in which said management information has been recorded.

3. An information recording/reproducing apparatus according to claim 2, wherein said predetermined timing occurs each time that one recording operation is complete, plural recording operations are complete, said recording medium is inserted or a constant time is complete.

4. An information recording/reproducing apparatus for recording user data on a recording medium having a first management information area, a second management information area and a user data area or for reproducing the user data from said recording medium, comprising:
a management information creation module which creates management information for managing the user data;
a recording module which operates to record the user data and the management information on said recording medium; and
a control module which controls said management information creation module and said recording module,
wherein said management information is recorded by switching over a recording destination of said management information to either said first or second management information area depending on a recording position of said user data until said recording medium is finalized and when said recording medium is finalized, a copy of said management information is recorded in the other management information area than the management information area in which said management information has been recorded.

5. An information recording/reproducing apparatus according to claim 4, wherein in switching over the recording destination of said management information depending on a recording position of said user data, a midpoint is defined at which the distance or time for the pickup to seek, from the recording position of said user data, said first management information area equals that for the pickup to seek said second management information area, and said management information is recorded in said first management information area when the recording position of said user data is closer to said first management information area than to said midpoint and said management information is recorded in said second management information area when the recording position of said user data is closer to said second management information area than to said midpoint.

6. An information recording/reproducing apparatus according to claim 3, wherein said recording medium is a Blu-ray disc on which information is recorded in a file format conforming to UDF (Universal Disc Format) 2.6.

7. An information recording/reproducing apparatus according to claims 3, said first management information area is arranged on the inner circumferential side of said recording medium and said second management information area is arranged on the outer circumferential side of said recording medium.

8. An information recording/reproducing apparatus according to claim 5, wherein said recording medium is a Blu-ray disc on which information is recorded in a file format conforming to UDF (Universal Disc Format) 2.6.

9. An information recording/reproducing apparatus according to claim 5, said first management information area is arranged on the inner circumferential side of said recording medium and said second management information area is arranged on the outer circumferential side of said recording medium.

10. An information recording method for recording information on a recording medium having a first management information area and a second management information area, wherein the management information is recorded in said first management information area until said recording medium is finalized and a copy of said management information is recorded in said second management information area when said recording medium is finalized.

11. An information recording method for recording information on a recording medium having a first management information area and a second management information area, wherein the management information is recorded by switching over a recording destination of said management information to either first or second management information area until said recording medium is finalized and when said recording medium is finalized, a copy of said management information is recorded in the other management information area than the management information area in which said management information has been recorded.

12. An information recording method for recording information on a recording medium having a first management information area and a second management information area, wherein the management information is recorded by switching over a recording destination of said management information to either said first or second management information area depending on a recording position of said user data until said recording medium is finalized and when said recording medium is finalized, a copy of said management information is recorded in the other management information area than the management information area in which said management information has been recorded.
